(19) United States
(12) Patent Application Publication
(10) Pub. No.: US 2019/0368965 A1
(43) Pub. Date: Dec. 5, 2019

(54) A METHOD AND SYSTEM FOR DETERMINING A LEAK FLOW OF A VACUUM SYSTEM OF A VACUUM FILTER

(71) Applicant: Lappeenrannan-Lahden teknillinen yliopisto LUT, LAPPEENRANTA (FI)

(72) Inventors: Manu HUTTUNEN, LAPPEENRANTA (FI); Lauri NYGREN, LAPPEENRANTA (FI); Teemu KINNARINEN, LAPPEENRANTA (FI); Tuomo LINDH, LAPPEENRANTA (FI); Jero AHOLA, LAPPEENRANTA (FI); Antti HÄKKINEN, LAPPEENRANTA (FI); Vesa KARVONEN, LAPPEENRANTA (FI); Bjarne EKBERG, LAPPEENRANTA (FI)

(21) Appl. No.: 16/478,695

(22) PCT Filed: Jan. 8, 2018
(86) PCT No.: PCT/FI2018/050010

§ 371 Date: Jul. 17, 2019

(30) Foreign Application Priority Data
Jan. 17, 2017 (FI) 20175032

(51) Int. Cl. G01M 3/26; F04B 51/00

(52) U.S. Cl. CPC G01M 3/26; F04B 51/00

(57) ABSTRACT

A system for determining a leak flow of a vacuum system of a vacuum filter includes a controller for adjusting speed of a filtration media of the vacuum filter and/or for adjusting supply rate of slurry onto the filtration media. The system includes a pressure sensor for determining pressure difference affecting over the filtration media and a layer of the slurry carried by the filtration media, and a device for determining flow rate through a vacuum pump that maintains the pressure difference. The speed of the filtration media and/or the supply rate of the slurry is/are adjusted so that the slurry is fully saturated by liquid along a whole filtration area affected by the pressure difference. Thus, fluid flow through the layer of the slurry is negligible and therefore the determined flow rate is indicative of the leak flow of the vacuum system.

### FIELD OF THE DISCLOSURE

The disclosure relates generally to vacuum filters for liquid removal, e.g. dewatering. More particularly, the disclosure relates to a method and to a system for determining a leak flow of a vacuum system of a vacuum filter.

### BACKGROUND

A vacuum filter for liquid removal, e.g. dewatering, comprises typically a filtration media and a vacuum system for effecting pressure difference over the filtration media and a layer of slurry, i.e. a slurry cake, carried by the filtration media. The filtration media is moving and slurry having high liquid-content is supplied onto a surface of the filtration media. The above-mentioned pressure difference sucks liquid from the slurry through the filtration media when the slurry travels through a filtration area affected by the pressure difference. Slurry from which at least a part of the liquid has been removed is peeled off from the surface of the filtration media and delivered to further processing or storing. A vacuum filter for liquid removal can be for example a rotary vacuum drum-filter, a rotary vacuum disc-filter, or a vacuum band-filter.

In many cases, it would be advantageous to know which part of a fluid flow through a vacuum pump which maintains the above-mentioned pressure difference represents the above-described liquid removal process and which part of the fluid flow represents a leak flow of the vacuum system of the vacuum filter. An estimate of the leak flow can be used for e.g. monitoring the condition of the vacuum system. The estimate of the leak flow can be used also for monitoring the condition of the filter media, e.g. for detecting a blinding or rupturing of the filtering media. Therefore, the estimate of the leak flow can be used as a tool for preventive maintenance of the vacuum filter. Furthermore, the estimate of the leak flow is useful when estimating a fluid flow through the slurry cake during a filtration process. Thus, the estimate of the leak flow can be used for improving the accuracy of the control of the filtration process.

### SUMMARY

The following presents a simplified summary in order to provide a basic understanding of some embodiments of the invention. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In accordance with the invention, there is provided a new system for determining a leak flow of a vacuum system of a vacuum filter that is suitable for removing liquid from slurry. A system according to the invention comprises:
a controller for adjusting one or more filtration parameters comprising at least one of the following: speed of a filtration media of the vacuum filter, and supply rate of the slurry onto the filtration media,
a pressure sensor for determining pressure difference affecting over the filtration media and a layer of the slurry carried by the filtration media, and
a device for determining a flow rate value indicative of flow rate through a vacuum pump configured to maintain the pressure difference.

The above-mentioned controller is configured to adjust the one or more filtration parameters so that the layer of the slurry is fully saturated by the liquid along a whole filtration area affected by the pressure difference. In this document, the wording “fully saturated by the liquid” means a situation in which there is no gas space between solid particles of the slurry, i.e. rooms between solid particles of the slurry are filled with the liquid so that the above-mentioned layer of the slurry is free from gas channels, e.g. air channels.

Fluid flow, e.g. air flow, through the layer of the slurry that is fully saturated by the liquid is negligible and therefore the determined flow rate is indicative of the leak flow of the vacuum system. The flow rate can be determined for example with a flow meter at the outlet or inlet of the vacuum pump. It is also possible that the device for determining the flow rate value comprises a processor for forming an estimate for the flow rate based on the pressure difference and the rotational speed of the vacuum pump.

The controller is advantageously, but not necessarily, configured to control the vacuum pump to vary the pressure difference and to control a data recorder to record data expressing the leak flow at different pressure differences. A look-up table can be constructed based on the recorded data and/or a suitable mathematical model having adjustable parameters can be fitted to the recorded data. The look-up table and/or the mathematical model can be used for e.g. condition monitoring of the vacuum system and/or condition monitoring of the filtration media during normal operation of the vacuum filter. The look-up table and/or the mathematical model can be used also for improving the accuracy of the control of the vacuum filter during its normal operation.

In accordance with the invention, there is provided also a new method for determining a leak flow of a vacuum system of a vacuum filter that is suitable for removing liquid from slurry. A method according to the invention comprises:
determining pressure difference affecting over a filtration media of the vacuum filter and a layer of the slurry carried by the filtration media, and
determining a flow rate value indicative of flow rate through a vacuum pump maintaining the pressure difference,

In the method according to the invention, the above-mentioned layer of the slurry is fully saturated by the liquid along a whole filtration area affected by the pressure difference so as to arrange the determined flow rate value to be indicative of the leak flow of the vacuum system.

A number of exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying embodiments when read in connection with the accompanying drawings.

The verbs “to comprise” and “to include” are used in this document as open limitations that neither exclude nor require the existence of also un-recited features. The features recited in the accompanied dependent claims are mutually freely combinable unless otherwise explicitly stated. Furthermore, it is to be understood that the use of “a” or “an”, i.e. a singular form, throughout this document does as such not exclude a plurality.

### BRIEF DESCRIPTION OF THE FIGURES

Exemplifying and non-limiting embodiments of the invention and their advantages are explained in greater details below in the sense of examples and with reference to the accompanying drawings, in which:

FIG. 1 illustrates a system according to an exemplifying and non-limiting embodiment of the invention for determining a leak flow of a vacuum system of a vacuum filter, and

FIG. 2 is a flowchart of a method according to an exemplifying and non-limiting embodiment of the invention for determining a leak flow of a vacuum system of a vacuum filter.

### DESCRIPTION OF EXEMPLIFYING EMBODIMENTS

The specific examples provided in the description below should not be construed as limiting the scope and/or the applicability of the accompanied claims. Lists and groups of examples provided in the description are not exhaustive unless otherwise explicitly stated.

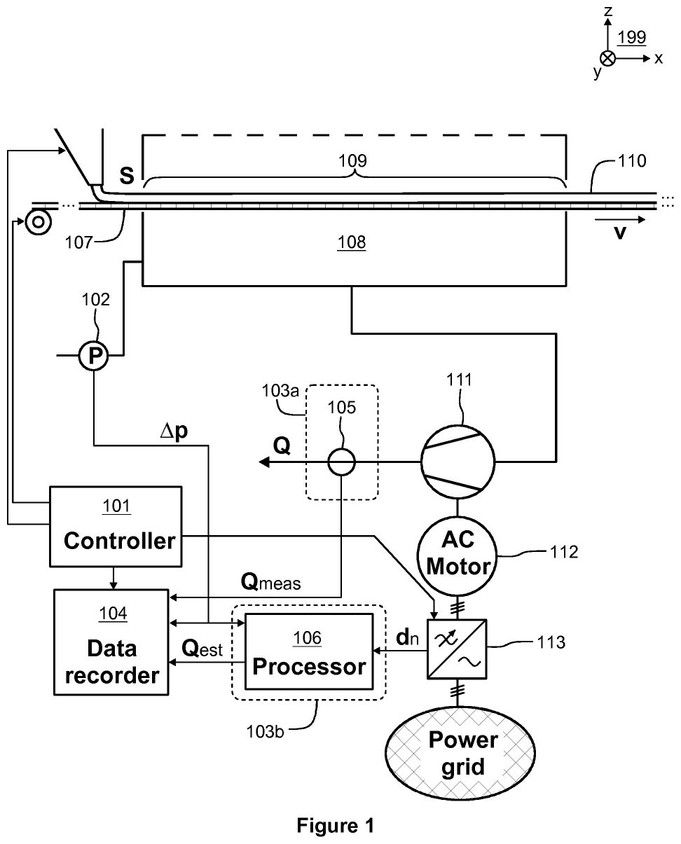

FIG. 1 illustrates a system according to an exemplifying and non-limiting embodiment of the invention for determining a leak flow of a vacuum system 108 of a vacuum filter. In this exemplifying case, the vacuum filter is a vacuum band-filter that comprises a filtration media 107 configured to transfer a layer of slurry 110, i.e. a cake of slurry, in the positive x-direction of a coordinate system 199. In FIG. 1, only a part of the filtration media 107 is shown. The vacuum system 108 is configured to suck liquid from the slurry 110 through the filtration media 107. The liquid being removed from the slurry 110 can be e.g. water.

The system for determining the leak flow of the vacuum system 108 comprises a controller 101 for adjusting one or more filtration parameters which comprise the speed v of the filtration media 107 and/or the supply rate S of the slurry 110 onto the filtration media 107. The unit of the supply rate S can be e.g. kg/s or I/s. The system comprises a pressure sensor 102 for determining pressure difference Δp affecting over the filtration media 107 and the layer of the slurry 110 carried by the filtration media 107. The pressure difference Δp may express the level of the vacuum of the vacuum system 108 with respect to the barometric pressure i.e. the atmospheric pressure acting from above on the layer of the slurry 110. The system comprises a device 103a for determining a flow rate value indicative of flow rate Q through a vacuum pump 111 that is configured to maintain the pressure difference Δp. In this exemplifying case, the device 103a comprises a flow meter 105 at the outlet or inlet of the vacuum pump 111. Therefore, in this exemplifying case, the determined flow rate value is a measured flow rate value Qₘₑₐₛ. The controller 101 is configured to adjust the speed v of the filtration media 107 and/or the supply rate S of the slurry 110 so that the layer of the slurry 110 is fully saturated by the liquid along a whole filtration area 109 affected by the pressure difference Δp. Fluid flow, e.g. air flow, through the layer of the slurry 110 that is fully saturated by the liquid is negligible, and therefore the measured flow rate value Qₘₑₐₛ is indicative of the leak flow of the vacuum system 108.

A system according to another exemplifying and non-limiting embodiment of the invention comprises a device 103b for forming an estimate Qₑₛₜ for the flow rate Q of the vacuum pump 111. The estimate Qₑₛₜ is indicative of the leak flow of the vacuum system 108 when the layer of the slurry 110 is fully saturated by the liquid along the whole filtration area 109. The device 103b comprises a processor 106 for obtaining the estimate Qₑₛₜ on the basis of the pressure difference Δp and data dₙ indicative of the rotational speed of the vacuum pump 111. The processor 106 can be configured to maintain for example a look-up table which returns the estimate Qₑₛₜ when the pressure difference Δp and the data dₙ indicative of the rotational speed are used as look-up keys. In the exemplifying case illustrated in FIG. 1, the vacuum pump 111 is driven with an alternating current “AC” motor 112 that is supplied with a frequency converter 113. The data dₙ indicative of the rotational speed can be for example a value of the supply frequency of the AC-motor. In the exemplifying case illustrated in FIG. 1, the frequency converter 113 is configured to deliver the data dₙ to the processor 106.

A system according to an exemplifying and non-limiting embodiment of the invention comprises both of the above-mentioned devices 103a and 103b. A difference between the measured and estimated values Qₘₑₐₛ and Qₑₛₜ can be used for e.g. condition monitoring of the vacuum pump 111, the AC-motor 112, and/or the frequency converter 113.

A system according to an exemplifying and non-limiting embodiment of the invention further comprises a data recorder 104 for recording data that expresses the determined leak flow of the vacuum system 108 and the pressure difference Δp.

In a system according to an exemplifying and non-limiting embodiment of the invention, the controller 101 is configured to control the vacuum pump 111 to vary the pressure difference Δp so as to obtain data expressing the leak flow at different pressure differences. The pressure difference Δp can be varied by varying the rotational speed of the vacuum pump 111.

In a system according to another exemplifying and non-limiting embodiment of the invention, the controller 101 is configured to control the vacuum pump 111 to vary the pressure difference Δp and to control the data recorder 104 to record data expressing the leak flow at different pressure differences. The controller 101 can be configured to construct a look-up table based on the recorded data and/or to fit a suitable mathematical model having adjustable parameters to the recorded data. The look-up table and/or the mathematical model can be used for e.g. condition monitoring of the vacuum system 108 and/or condition monitoring of the filtration media 107 during normal operation of the vacuum filter. The look-up table and/or the mathematical model can be used also for improving the accuracy of the control of the vacuum filter during its normal operation.

The implementation of the controller 101 can be based on one or more analogue circuits, one or more digital processing circuits, or a combination thereof. Each digital processing circuit can be a programmable processor circuit provided with appropriate software, a dedicated hardware processor such as for example an application specific integrated circuit “ASIC”, or a configurable hardware processor such as for example a field programmable gate array “FPGA”. Furthermore, the controller 101 may comprise one or more memory circuits each of which can be for example a Random Access Memory “RAM” circuit. Correspondingly, the implementation of the processor 106 can be based on one or more analogue circuits, one or more digital processing circuits, or a combination thereof. Furthermore, the processor 106 may comprise one or more memory circuits.

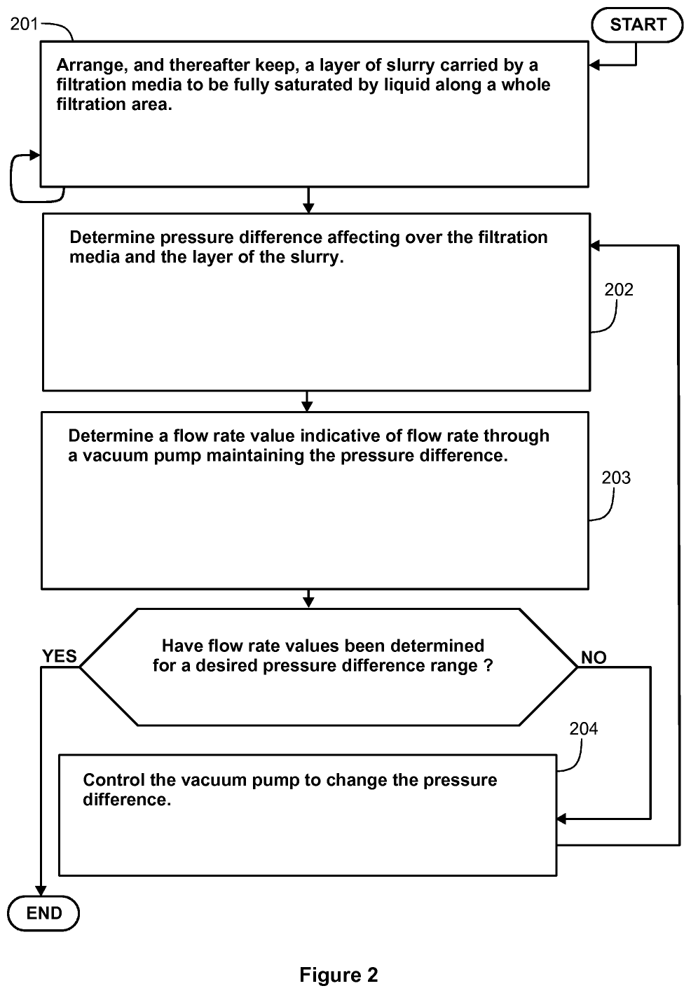

FIG. 2 shows a flowchart of a method according to an exemplifying and non-limiting embodiment of the invention for determining a leak flow of a vacuum system of a vacuum filter that is suitable for removing liquid from slurry. The method comprises the following actions:
action 201: arranging, and thereafter keeping, a layer of the slurry carried by a filtration media of the vacuum filter to be fully saturated by the liquid along a whole filtration area of the vacuum filter,
action 202: determining pressure difference affecting over the filtration media and the layer of the slurry, and
action 203: determining a flow rate value indicative of flow rate through a vacuum pump maintaining the pressure difference, the determined flow rate value being indicative of the leak flow of the vacuum system.

A method according to an exemplifying and non-limiting embodiment of the invention further comprises action 204: controlling the vacuum pump to vary the pressure difference so as to obtain data expressing the leak flow at different pressure differences.

A method according to an exemplifying and non-limiting embodiment of the invention further comprises fitting a mathematical model having adjustable parameters to the data expressing the leak flow at the different pressure differences.

In a method according to an exemplifying and non-limiting embodiment of the invention, the flow rate value indicative of the leak flow is determined with a flow meter at the outlet or inlet of the vacuum pump.

A method according to another exemplifying and non-limiting embodiment of the invention comprises estimating the flow rate of the vacuum pump based on the pressure difference and data indicative of the rotational speed of the vacuum pump.

The specific examples provided in the description given above should not be construed as limiting. Therefore, the invention is not limited merely to the exemplifying and non-limiting embodiments described above. Lists and groups of examples provided in the description are not exhaustive unless otherwise explicitly stated.

1. A system for determining a leak flow of a vacuum system of a vacuum filter, the system comprising:
a controller for adjusting one or more filtration parameters comprising at least one of the following: speed of a filtration media of the vacuum filter, and supply rate of slurry onto the filtration media,
a pressure sensor for determining pressure difference affecting over the filtration media and a layer of the slurry carried by the filtration media, and
a device for determining a flow rate value indicative of flow rate through a vacuum pump configured to maintain the pressure difference,
wherein the controller is configured to adjust the one or more filtration parameters so that the layer of the slurry is fully saturated by liquid along a whole filtration area affected by the pressure difference so as to arrange the determined flow rate value to be indicative of the leak flow of the vacuum system.

2. A system according to claim 1, wherein the system further comprises a data recorder for recording data expressing the leak flow and the pressure difference.

3. A system according to claim 1, wherein the controller is configured to control the vacuum pump to vary the pressure difference so as to obtain data expressing the leak flow at different pressure differences.

4. A system according to claim 3, wherein the controller is configured fit a mathematical model having adjustable parameters to the data expressing the leak flow at the different pressure differences.

5. A system according to claim 1, wherein the device for determining the flow rate value comprises a flow meter at an outlet or inlet of the vacuum pump.

6. A system according to claim 1, wherein the device for determining the flow rate value comprises a processor for obtaining an estimate for the flow rate of the vacuum pump based on the pressure difference and data indicative of rotational speed of the vacuum pump.

7. A method for determining a leak flow of a vacuum system of a vacuum filter, the method comprising:
determining pressure difference affecting over a filtration media of the vacuum filter and a layer of slurry carried by the filtration media, and
determining a flow rate value indicative of flow rate through a vacuum pump maintaining the pressure difference,
wherein the layer of the slurry is fully saturated by liquid along a whole filtration area affected by the pressure difference so as to arrange the determined flow rate value to be indicative of the leak flow of the vacuum system.

8. A method according to claim 7, wherein the method comprises controlling the vacuum pump to vary the pressure difference so as to obtain data expressing the leak flow at different pressure differences.

9. A method according to claim 8, wherein the method comprises fitting a mathematical model having adjustable parameters to the data expressing the leak flow at the different pressure differences.

10. A method according to claim 7, wherein the flow rate value is determined with a flow meter at an outlet or inlet of the vacuum pump.

11. A method according to claim 7, wherein the flow rate value is determined by estimating the flow rate of the vacuum pump based on the pressure difference and data indicative of rotational speed of the vacuum pump.

12. A system according to claim 2, wherein the controller is configured to control the vacuum pump to vary the pressure difference so as to obtain data expressing the leak flow at different pressure differences.

13. A system according to claim 12, wherein the controller is configured fit a mathematical model having adjustable parameters to the data expressing the leak flow at the different pressure differences.

14. A system according to claim 2, wherein the device for determining the flow rate value comprises a flow meter at an outlet or inlet of the vacuum pump.

15. A system according to claim 3, wherein the device for determining the flow rate value comprises a flow meter at an outlet or inlet of the vacuum pump.

16. A system according to claim 4, wherein the device for determining the flow rate value comprises a flow meter at an outlet or inlet of the vacuum pump.

17. A system according to claim 2, wherein the device for determining the flow rate value comprises a processor for obtaining an estimate for the flow rate of the vacuum pump based on the pressure difference and data indicative of rotational speed of the vacuum pump.

18. A system according to claim 3, wherein the device for determining the flow rate value comprises a processor for obtaining an estimate for the flow rate of the vacuum pump based on the pressure difference and data indicative of rotational speed of the vacuum pump.

19. A system according to claim 4, wherein the device for determining the flow rate value comprises a processor for obtaining an estimate for the flow rate of the vacuum pump based on the pressure difference and data indicative of rotational speed of the vacuum pump.

20. A system according to claim 5, wherein the device for determining the flow rate value comprises a processor for obtaining an estimate for the flow rate of the vacuum pump based on the pressure difference and data indicative of rotational speed of the vacuum pump.
